(19) United States
(12) Patent Application Publication
(10) Pub. No.: US 2026/0347182 A1
(43) Pub. Date: Nov. 5, 2026

(54) IODINE RECOVERY METHOD AND SYSTEM

(71) Applicants: SK INNOVATION CO., LTD., Seoul (KR); SK ON CO., LTD., Seoul (KR)

(72) Inventors: Hee Du LEE, Daejeon (KR); Soo Kil KANG, Daejeon (KR); Jae Hun JEONG, Daejeon (KR)

(21) Appl. No.: 19/645,300

(22) Filed: Apr. 13, 2026

(30) Foreign Application Priority Data
Apr. 30, 2025 (KR) 10-2025-0057757
Sep. 25, 2025 (KR) 10-2025-0139260

(51) Int. Cl. C01B 7/14; B01D 3/00; B01D 53/14; B01D 53/18

(52) U.S. Cl. CPC C01B 7/14; B01D 3/00; B01D 53/1412; B01D 53/1418; B01D 53/18; B01D 2257/2068; B01D 2259/40079

(57) ABSTRACT

An iodine recovery method and system, the iodine recovery method including supplying to an absorption tower in a co-current flow, a mixed gas including gaseous iodine (I₂) and gaseous hydrogen iodide (HI), and an aqueous hydrogen iodide solution in a liquid phase. The iodine recovery system includes an absorption tower, wherein a mixed gas including gaseous iodine (I₂) and gaseous hydrogen iodide (HI), and an aqueous hydrogen iodide solution in a liquid phase are supplied to the absorption tower in a co-current flow.

### CROSS-REFERENCE TO RELATED APPLICATION

This application claims priority to and the benefit of Korean Patent Applications No. 10-2025-0057757, filed on Apr. 30, 2025, and No. 10-2025-0139260, filed on Sep. 25, 2025, under 35 U.S.C. § 119, the entire contents of which are incorporated herein by reference.

### BACKGROUND

### 1. Technical Field

The embodiments of the present disclosure generally relate to an iodine recovery method and system.

### 2. Description of Related Art

Iodine is produced or used in various industrial processes, and methods for recovering iodine have been proposed. For example, a sublimation-deposition method, which sublimates iodine into a gaseous phase and then cools it to recover it in solid form, and a reductive recovery method, which converts iodine into iodide ions (I⁻) using a reducing agent and then recovers it, are known in the art. In the case of the sublimation-deposition method, the solid iodine deposited by the sublimation-deposition process can adhere to the walls of an apparatus or the inner walls of pipes, which may cause partial or complete blockage of the pipe. In addition, in the case of the sublimation-deposition method, if solid iodine accumulates inside the apparatus to a thickness greater than a predetermined level, problems such as reduced heat transfer efficiency, process operation instability, and difficulty in continuous process operation may occur. The reductive recovery method is a method in which iodine is converted into iodide ions using a reducing agent and then recovered through an electrochemical method or an additional treatment process. However, to ensure completeness of the reduction reaction, excessive use of a reducing agent may be required, which may increase the generation of by-products and the burden on the water treatment process. In addition, in the case of the reductive recovery method, if iodide ions are regenerated into iodine (I₂), a separate oxidation process is additionally required, which may increase the complexity of the overall process.

### SUMMARY

Embodiments of the present disclosure provide an iodine recovery method with improved reliability and process operability.

Other embodiments of the present disclosure provide an iodine recovery system with improved reliability and process operability.

An iodine recovery method according to embodiments of the present disclosure may include supplying to an absorption tower in a co-current flow, a mixed gas including gaseous iodine (I₂) and gaseous hydrogen iodide (HI), and an aqueous hydrogen iodide solution in a liquid phase.

In an embodiment, the co-current flow may be formed in a direction from an upper portion toward a lower portion of the absorption tower.

In an embodiment, a volume ratio of the gaseous iodine (I₂) to the gaseous hydrogen iodide (HI) in the mixed gas may be 10:1 to 1:20.

In an embodiment, the absorption tower may include a first gas inlet through which the mixed gas is supplied, and the temperature of the first gas inlet may be set to 120 °C or higher.

In an embodiment, the absorption tower may include a first liquid inlet through which the aqueous hydrogen iodide solution in a liquid phase is supplied, and a temperature of the first liquid inlet may be set to 100 °C or lower.

In an embodiment, a ratio of a molar flow rate of hydrogen iodide in the aqueous hydrogen iodide solution to a molar flow rate of gaseous iodine in the mixed gas supplied to the absorption tower may be set to 0.7 or more.

In an embodiment, the temperature inside the absorption tower may be set to 100 °C or lower.

In an embodiment, the molar concentration of hydrogen iodide in the aqueous hydrogen iodide solution supplied to the absorption tower may be 0.1 mol/L to 10 mol/L.

In an embodiment, the iodine recovery method may further include supplying a first discharged liquid discharged from the absorption tower to a first column.

In an embodiment, the iodine recovery method may further include discharging a second discharged gas including hydrogen iodide and water from the first column by distillation.

In an embodiment, the iodine recovery method may further include discharging a second discharged liquid including liquid iodine (I₂) from the first column by distillation.

In an embodiment, the iodine recovery method may further include recycling the second discharged gas.

In an embodiment, the iodine recovery method may further include recycling the second discharged liquid.

An iodine recovery system according to embodiments of the present disclosure may include an absorption tower, wherein a mixed gas including gaseous iodine (I₂) and gaseous hydrogen iodide (HI), and an aqueous hydrogen iodide solution in a liquid phase may be supplied to the absorption tower in a co-current flow.

In an embodiment, the absorption tower may include a first gas inlet through which the mixed gas is supplied and a first liquid inlet through which the aqueous hydrogen iodide solution is supplied in a liquid phase, at an upper portion thereof, and a first liquid outlet through which a first discharged liquid is discharged and a first gas outlet through which a first discharged gas is discharged, at a lower portion thereof.

In an embodiment, the iodine recovery system may further include a mixed gas supply unit configured to control a volume ratio of the gaseous iodine (I₂) to the gaseous hydrogen iodide (I) in the mixed gas to be 10:1 to 1:20.

In an embodiment, the iodine recovery system may further include a first temperature control unit configured to control a temperature of the first gas inlet to be 120 °C or higher.

In an embodiment, the iodine recovery system may further include a second temperature control unit configured to control a temperature of the first liquid inlet to be 100 °C or lower.

In an embodiment, the iodine recovery system may further include a flow control unit configured to control a ratio of a molar flow rate of hydrogen iodide in the aqueous hydrogen iodide solution to a molar flow rate of gaseous iodine in the mixed gas supplied to the absorption tower to be 0.7 or higher.

In an embodiment, the iodine recovery system may further include a third temperature control unit configured to control a temperature inside the absorption tower to be 100 °C or lower.

The iodine recovery method according to embodiments of the present disclosure may provide improved reliability and process operability.

The iodine recovery system according to embodiments of the present disclosure may provide improved reliability and process operability.

According to the iodine recovery method and system, the excessive use of a reducing agent is unnecessary, such that subsequent processes required for byproduct removal, filtration, and cleaning may be reduced or eliminated, thereby reducing environmental impact.

In addition, according to the iodine recovery method and system, the number of overall processes may be reduced, which may improve iodine recovery speed and productivity.

### BRIEF DESCRIPTION OF THE DRAWINGS

The above and other embodiments, features and advantages of the present disclosure will be more clearly understood from the following detailed description taken in conjunction with the accompanying drawings, in which:

FIG. 1 is a schematic process flow diagram of an iodine recovery method according to an embodiment of the present disclosure;

FIG. 2 is a schematic process flow diagram of an iodine recovery method according to another embodiment of the present disclosure;

FIG. 3 is a schematic process flow diagram of an iodine recovery method according to still another embodiment of the present disclosure;

FIG. 4 is a schematic block diagram of an iodine recovery system according to an embodiment of the present disclosure; and

FIG. 5 is a schematic block diagram of an iodine recovery system according to another embodiment of the present disclosure.

### DETAILED DESCRIPTION

Hereinafter, various embodiments of the present disclosure will be described in detail with reference to the drawings so that a person of ordinary knowledge in the technical field to which the present disclosure pertains may implement the embodiments. However, the various embodiments described are merely illustrative, and the embodiments are not limited to the embodiments described herein.

### Iodine Recovery Method

Hereinafter, embodiments of the present disclosure are further described with reference to specific experimental examples. The examples and comparative examples included in the experimental examples are merely illustrative and do not limit the scope of the appended claims.

FIG. 1 is a schematic process flow diagram of an iodine recovery method according to an embodiment of the present disclosure.

The iodine recovery method according to an embodiment of the present disclosure may include supplying to an absorption tower in a co-current flow, a mixed gas including gaseous iodine (I₂) and gaseous hydrogen iodide (HI), and an aqueous hydrogen iodide solution in a liquid phase (operation S10). In operation S10, a mixed gas including gaseous iodine (I₂) and gaseous hydrogen iodide (HI), and an aqueous hydrogen iodide solution in a liquid phase may be supplied to an absorption tower such that the mixed gas and the aqueous hydrogen iodide solution flow in a co-current manner within the absorption tower.

According to the recovery method, high-temperature gaseous iodine may be prevented from flowing into a relatively large amount of low-temperature aqueous hydrogen iodide solution, such that the gaseous iodine and the aqueous hydrogen iodide solution may not contact each other at a gas inlet of the absorption tower and a surrounding region thereof. Accordingly, in an initial region introduced into the absorption tower, for example, in the vicinity of the gas inlet, the temperature of the gaseous iodine may not decrease abruptly, thereby preventing or reducing precipitation or adhesion of solid iodine at the gas inlet of the absorption tower and the surrounding region thereof.

In an embodiment, the co-current flow may be formed in a direction from an upper portion toward a lower portion of the absorption tower.

If the co-current flow is formed in a direction from the lower portion toward the upper portion of the absorption tower, the aqueous hydrogen iodide solution may accumulate in the lower portion of the absorption tower due to gravity over time, thereby forming a liquid layer. When the mixed gas flows into the liquid layer, a counter-current flow may be formed.

When a counter-current flow is formed, the temperature of the gaseous iodine may decrease abruptly as the gaseous iodine comes into contact with a relatively large amount of aqueous hydrogen iodide solution at the gas inlet and a surrounding region thereof. This may cause precipitation and/or adhesion of solid iodine at the gas inlet and the surrounding region thereof.

Therefore, the recovery method according to the embodiments of the present disclosure may effectively suppress or reduce precipitation and adhesion of solid iodine by applying a co-current flow, while preventing localized cooling in a surrounding region of the gas inlet.

In an embodiment, a ratio of a volume of the gaseous iodine (I₂) to a volume of the gaseous hydrogen iodide (HI) in the mixed gas may be 10:1 to 1:20, for example, 1:1 to 1:20. Accordingly, the iodine recovery efficiency may be improved when iodine is recovered in a liquid phase rather than in a gaseous phase.

The content of gaseous iodine in the mixed gas may be 1% by volume (“vol %”) or more. The content of gaseous iodine may be, for example, 1 vol % to 50 vol %, 1 vol % to 20 vol %, or 5 vol % to 20 vol %.

In an embodiment, the absorption tower may include a first gas inlet through which the mixed gas is supplied, and a temperature of the first gas inlet may be set to 120 °C or higher. The temperature of the first gas inlet may refer to a temperature of a structure defining the first gas inlet and/or a region in the vicinity thereof, and a temperature of the mixed gas supplied through the first gas inlet may be controlled within the above temperature range.

Accordingly, precipitation of iodine at the first gas inlet and/or a surrounding region thereof may be further suppressed.

A temperature of a first gas inlet may be set, for example, to 120 °C to 550 °C.

In an embodiment, the temperature of the first gas inlet may be set to 150 °C to 300 °C.

For example, the absorption tower may include a first liquid inlet through which the aqueous hydrogen iodide solution is supplied, and a temperature of the first liquid inlet may be set to at least 5 °C lower than a boiling point of the aqueous hydrogen iodide solution. The temperature of the first liquid inlet may refer to a temperature of a structure defining the first liquid inlet and/or a region in the vicinity thereof, and a temperature of the aqueous hydrogen iodide solution supplied through the first liquid inlet may be controlled within the above temperature range. In an embodiment, the absorption tower may include a first liquid inlet through which the aqueous hydrogen iodide solution is supplied, and a temperature of the first liquid inlet may be set to 100 °C or lower.

Therefore, vaporization of the aqueous hydrogen iodide solution may be prevented or suppressed.

In an embodiment, a ratio of a molar flow rate of hydrogen iodide in the aqueous hydrogen iodide solution to a molar flow rate of gaseous iodine in the mixed gas supplied to the absorption tower may be set to 0.7 or more, and may be set to, for example, 0.7 to 5, 1 to 4, or 2 to 3. That is, the ratio may refer to a ratio of a molar flow rate of hydrogen iodide to a molar flow rate of gaseous iodine.

Accordingly, an amount of gaseous iodine that is discharged without being dissolved and/or complexed within the aqueous hydrogen iodide solution may be effectively reduced.

In an embodiment, the molar concentration of hydrogen iodide in the aqueous hydrogen iodide solution supplied to the absorption tower may be 0.1 mol/L to 10 mol/L, for example, the molar concentration may be 1 mol/L to 8 mol/L or 2 mol/L to 7 mol/L.

Therefore, gaseous iodine may be more easily dissolved into the aqueous hydrogen iodide solution.

In an embodiment, the flow rate of the mixed gas may be set to 0.1 g/s to 10,000 g/s.

In an embodiment, the flow rate of the aqueous hydrogen iodide solution may be set to 0.1 g/s to 100,000 g/s.

The flow rates of the mixed gas and the aqueous hydrogen iodide solution may be selected within the above-described ranges to correspond to laboratory-scale, pilot-scale, or commercial-scale operation, depending on a throughput of an iodine recovery target material, a reactor scale, operational objectives, and the like.

In an embodiment, a residence time of the mixed gas within the absorption tower may be 1 minute to 30 minutes, for example, 1 minute to 20 minutes, 1 minute to 10 minutes, or 2 minutes to 5 minutes. The residence time may be defined, for example, as a time period from when the mixed gas is introduced into the absorption tower until the mixed gas is discharged from the absorption tower.

In an embodiment, a temperature inside the absorption tower may be maintained at 100 °C or lower. For example, the temperature inside the absorption tower may be maintained in a range of 10 °C to 60 °C or in a range of 20 °C to 30 °C.

Therefore, vaporization of hydrogen iodide within the aqueous hydrogen iodide solution may be prevented, thereby preventing a further decrease in concentration. In addition, a reduction in an amount of gaseous iodine dissolved within the aqueous hydrogen iodide solution may be prevented or suppressed.

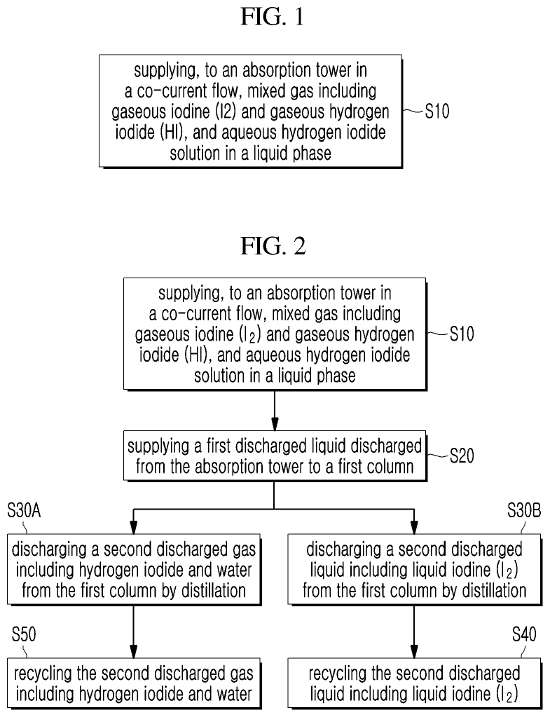

FIG. 2 is a schematic process flow diagram of an iodine recovery method according to another embodiment of the present disclosure.

In an embodiment, the recovery method may further include supplying a first discharged liquid discharged from the absorption tower to a first column (operation S20).

The first discharged liquid may include, for example, iodide ions (I⁻), iodine molecules (I₂), triiodide ions (I₃), complexes of hydrogen iodide (HI) and iodine such as HI₃, HI₅, as well as water (120), hydrogen iodide (HI), H₃O⁺ and/or H⁺. That is, the first discharged liquid may include an aqueous hydrogen iodide solution in which gaseous iodine (I₂) is dissolved, and may include ions, molecules, and complexes thereof that may exist in an equilibrium state within the aqueous hydrogen iodide solution.

The complexes of HI and iodine may be formed, for example, by the following reaction equations.

HI+I₂⇔HI₃

HI₃+I₂⇔HI₅

In an embodiment, the first column may be, for example, a distillation column.

The distillation column may be, for example, a stripper.

In an embodiment, the recovery method may further include supplying a first discharged gas discharged from the absorption tower to a caustic tower. The first discharged gas may, for example, include gaseous hydrogen iodide. Accordingly, the first discharged gas may be subjected to treatment.

In another embodiment, the recovery method may include recycling the gaseous hydrogen iodide included in the first discharged gas.

In an embodiment, the recovery method may further include discharging a second discharged gas including hydrogen iodide and water from the first column by distillation (operation S30A).

In an embodiment, the recovery method may further include discharging a second discharged liquid including liquid iodine (I₂) from the first column by distillation (operation S30B).

For example, the first discharged liquid supplied to the first column may be separated into the second discharged gas and the second discharged liquid by distillation. In a non-limiting embodiment, the stripper may bean apparatus for selectively removing aqueous hydrogen iodide solution including hydrogen iodide and water, which are capable of being vaporized, from the first discharged liquid. The inside of the stripper may be maintained at a temperature higher than the boiling point of the aqueous hydrogen iodide solution, for example, at a temperature at which hydrogen iodide and water can be vaporized from the aqueous hydrogen iodide solution, thereby evaporating the aqueous hydrogen iodide solution.

In an embodiment, the recovery method may further include recycling the second discharged liquid including liquid iodine (I₂) (operation S40).

In an embodiment, the second discharged liquid may include liquid iodine (I₂), i.e., iodine (I₂) recovered in a liquid state in an amount of 90% by weight (“wt %”) or more, 95 wt % or more, 99 wt % or more, or 99.99 wt % or more based on the total weight of the second discharged liquid. The upper limit is preferably as high as possible and is not particularly limited.

Since the second discharged liquid may be directly used in a recycling process without a separate additional purification process, energy efficiency may be enhanced, and process simplification and operational convenience may be improved.

The second discharged liquid may be provided, for example, to various reaction processes that use iodine as a raw material, thereby effectively recycling the second discharged liquid including liquid iodine.

The reaction process only needs to include iodine as one of the reaction raw materials and is not particularly limited.

In a non-limiting embodiment, the second discharged liquid may be supplied to a reactor. The second discharged liquid may be supplied to the reactor in a liquid state, or the iodine included in the second discharged liquid may be vaporized and supplied in a gaseous phase.

In a non-limiting embodiment, a mixed gas including gaseous iodine (I₂) and gaseous hydrogen iodide may be discharged from the reactor.

For example, iodine in a liquid state or in a gaseous phase and other reaction raw materials may be mixed, either separately or together, and introduced into the reactor. A high-temperature reaction may then be carried out within the reactor, resulting in a product including a mixed gas including gaseous iodine (I) and gaseous hydrogen iodide. By applying the iodine recovery method described herein, iodine included in the mixed gas may be efficiently recycled over a long period of time while suppressing or reducing damage to apparatuses or equipment caused by precipitation or adhesion of iodine.

In an embodiment, the recovery method may further include recycling the second discharged gas including hydrogen iodide and water (operation S50).

For example, the hydrogen iodide and water may be recovered, converted into an aqueous hydrogen iodide solution, and the aqueous hydrogen iodide solution in a liquid phase may be supplied to the absorption tower, and may be reused to dissolve the gaseous iodine in the absorption tower.

In an embodiment, the second discharged gas may include a mixture of the hydrogen iodide and the water in an amount of 90 vol % or more, 95 vol % or more, 99 vol % or more, or 99.99 vol % or more.

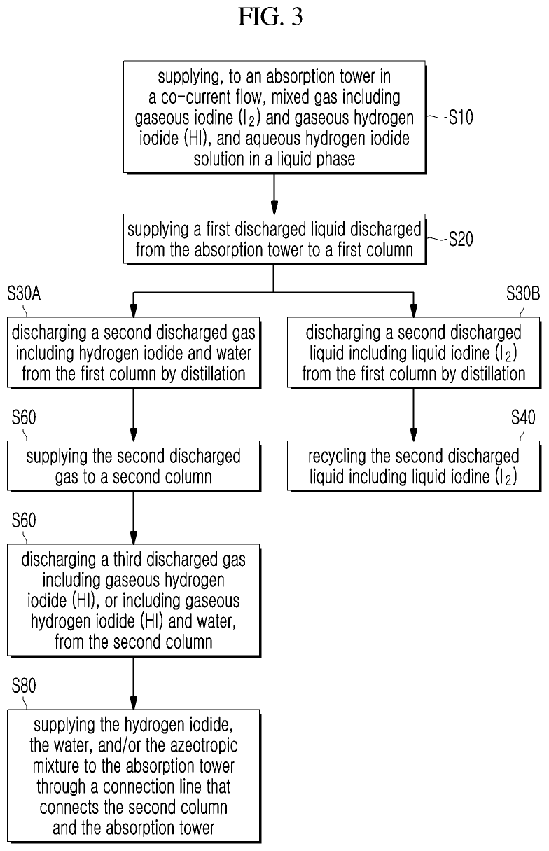

FIG. 3 is a schematic process flow diagram of an iodine recovery method according to still another embodiment of the present disclosure.

In an embodiment, the method may further include supplying the second discharged gas to a second column (operation S60).

For example, the second discharged gas may be supplied to the second column in a gaseous phase without undergoing a phase change through a connection line that connects the first column and the second column, or may be liquefied within the connection line and supplied to the second column in a liquid state.

In an embodiment, the second column may be a distillation column, and for example, the aqueous hydrogen iodide solution may be concentrated in the distillation column. In a non-limiting embodiment, azeotropic distillation of hydrogen iodide and water may be performed in the second column.

In an embodiment, the method may further include discharging a third discharged gas including gaseous hydrogen iodide (HI), or including gaseous hydrogen iodide (HI) and water, from the second column (operation S70).

For example, the third discharged gas may be discharged from an upper portion of the second column.

In a non-limiting embodiment, an azeotropic mixture of gaseous hydrogen iodide (HI) and water may be formed in the second column.

In a non-limiting embodiment, as the aqueous hydrogen iodide solution supplied to the second column is heated, during a process in which hydrogen iodide and water are vaporized together, the concentration of the aqueous hydrogen iodide solution may increase. When the concentration reaches approximately 57 wt % of hydrogen iodide, hydrogen iodide and water may form an azeotropic mixture and co-evaporate with a fixed composition. The azeotropic mixture may be discharged through a separate outlet from gaseous hydrogen iodide and/or water in which an azeotropic mixture is not formed.

The azeotropic mixture may be used in an iodine recovery or recycling process, or alternatively, the azeotropic mixture may be treated as a discharged gas through neutralization. In a non-limiting embodiment, the azeotropic mixture may be used to dissolve gaseous iodine, recover iodine through an oxidation reaction, recover high-concentration hydrogen iodide through further distillation, or treat wastewater through a neutralization reaction with sodium hydroxide.

In an embodiment, the recovery method may further include supplying the hydrogen iodide, the water, and/or the azeotropic mixture to the absorption tower through a connection line that connects the second column and the absorption tower (operation S80).

For example, the hydrogen iodide, the water, and/or the azeotropic mixture may be vaporized in the second column, and the vaporized hydrogen iodide, water, and/or the azeotropic mixture may be supplied to the absorption tower through the connection line. For example, the vaporized hydrogen iodide, water, and/or the azeotropic mixture within the connection line may be converted into an aqueous hydrogen iodide solution in a liquid phase by cooling condensation, or the like.

For example, hydrogen iodide and/or water may be further supplied to the connection line, and the molar concentration of the aqueous hydrogen iodide solution supplied to the absorption tower may be controlled by controlling a flow rate of additionally supplied hydrogen iodide and/or water in addition to the fluid supplied from the second column.

As illustrated in FIG. 2, in an embodiment, recycling of the second discharged gas may be directly performed according to operation S50.

As illustrated in FIG. 3, in another embodiment, the second discharged gas may be recycled to the absorption tower after undergoing an additional separation and concentration process including operations S60 to S80.

In an embodiment, the recovery method may further include supplying a caustic solution to the caustic tower.

In a non-limiting embodiment, the caustic solution may be an aqueous sodium hydroxide solution, an aqueous potassium hydroxide solution, or the like.

In the caustic tower, for example, hydrogen iodide included in the first discharged gas may react with the caustic solution to form an alkali metal iodide. The formed alkali metal iodide may be discharged from the caustic tower in an aqueous solution and removed. For example, components other than the alkali metal iodide may be discharged from the caustic tower and supplied to a drying tower.

In a non-limiting embodiment, the alkali metal iodide may be NaI, KI, or the like.

The iodine recovery method according to an embodiment may have an overall circulation structure, for example, wherein the iodine recovered through the absorption tower and the first column may be recycled, and/or the aqueous hydrogen iodide solution recovered through the first and second columns may be recycled. Accordingly, consumption of raw materials may be minimized and process efficiency may be enhanced.

In a non-limiting embodiment, the absorption tower may include a gas inlet through which a gas or a gas mixture is supplied, a liquid inlet through which a liquid such as aqueous hydrogen iodide solution is supplied, a gas outlet through which gas is discharged, and a liquid outlet through which a discharged liquid in which gas is dissolved is discharged. The absorption tower may be equipped with, for example, packing or trays installed inside a tower body to increase a contact area between gas and liquid, and may further be equipped with a dehydrator or the like, as needed.

In a non-limiting embodiment, the distillation column may include an inlet for supplying a mixture, an outlet for discharging components separated by distillation, and an outlet for discharging residual components excluding the separated components. The distillation column may be equipped with packing or trays installed inside a column body to enhance separation efficiency through contact between vapor and liquid, and may be equipped with a reflux device at an upper portion thereof, as needed.

The drying tower may be a device for improving efficiency of subsequent processes or preventing corrosion of equipment, for example, by using adsorption drying or condensation drying.

For example, the absorption tower, the column, the caustic tower, the drying tower, the reactor, and the like may be connected to each other by connection lines, and apparatuses and equipment additionally used for recycling may also be connected via the connection lines.

For example, the absorption tower, the column, the caustic tower, the drying tower, the reactor, and the like may include one or more inlets and outlets, through which a gaseous fluid or a liquid fluid may be supplied or discharged.

In a non-limiting embodiment, the connection line may be pipes, tubes, or the like, and may be formed of stainless steel, carbon steel, or various alloys.

### Iodine Recovery System

FIG. 2 is a schematic block diagram of an iodine recovery system 100 according to an embodiment of the present disclosure. The iodine recovery method described above may be carried out by the iodine recovery system 100, and descriptions of each component of the iodine recovery system 100 may refer to the foregoing descriptions of corresponding components.

The iodine recovery system 100 according to an embodiment of the present disclosure includes an absorption tower 30, and is configured to supply, to the absorption tower 30 in a co-current flow, a mixed gas including gaseous iodine (I₂) and gaseous hydrogen iodide (HI), and an aqueous hydrogen iodide solution in a liquid phase. That is, the absorption tower 30 may be configured to receive, in the co-current flow, the mixed gas including gaseous iodine (I₂) and gaseous hydrogen iodide (HI), and the aqueous hydrogen iodide solution in a liquid phase.

With this recovery system, high-temperature gaseous iodine may be prevented from flowing into a large amount of relatively low-temperature aqueous hydrogen iodide solution, such that the gaseous iodine and the aqueous hydrogen iodide solution may not contact each other at a gas inlet of the absorption tower 30 and a surrounding region thereof. Accordingly, the temperature of the gaseous iodine supplied into the absorption tower 30 may not decrease abruptly, thereby preventing or reducing precipitation or adhesion of solid iodine at the gas inlet of the absorption tower 30 and the surrounding region thereof.

In an embodiment, the absorption tower 30 may include, at an upper portion thereof, a first gas inlet through which the mixed gas is supplied and a first liquid inlet through which the aqueous hydrogen iodide solution is supplied, and at a lower portion thereof, a first liquid outlet through which a first discharged liquid is discharged from the absorption tower 30, and a first gas outlet through which the first discharged gas is discharged.

Accordingly, the co-current flow may be formed in a direction from the upper portion toward the lower portion of the absorption tower 30.

The upper portion and the lower portion of the absorption tower 30 may refer to an upper region and a lower region required for forming the co-current flow. For example, the upper portion of the absorption tower 30 may refer to an uppermost end and an adjacent region thereof, and the lower portion of the absorption tower 30 may refer to a lowermost end and an adjacent region thereof.

For example, based on the total height of the absorption tower 30, the first liquid inlet may be positioned at the uppermost end, or on a side surface within a height range of 15% or less of the total height measured from the uppermost end.

For example, based on the total height of the absorption tower 30, the first gas outlet may be positioned at the lowermost end, or on a side surface within a height range of 15% or less of the total height measured from the lowermost end.

In an embodiment, the recovery system may further include a first supply unit 10 (hereinafter, also referred to as a “mixed gas supply unit”) configured to control a volume ratio of the gaseous iodine (I₂) to the gaseous hydrogen iodide (HI) in the mixed gas to be 10:1 to 1:20. Descriptions of the mixed gas refer to the foregoing descriptions.

Accordingly, the iodine recovery efficiency may be improved when iodine is recovered in a liquid phase rather than in a gaseous phase.

In a non-limiting embodiment, the mixed gas supply unit may include, for example, a flow control valve configured to adjust a flow rate of an iodine-containing source gas, a flow controller configured to control an input amount of a remaining gas, or a sensor-based control device configured to detect a mixing ratio in real time and perform feedback control.

In an embodiment, the recovery system may further include a first temperature control unit configured to control the temperature of the first gas inlet to be 120 °C or higher. That is, the recovery system may further include the first temperature control unit configured to control the temperature of the first gas inlet to be 120 °C or higher.

Accordingly, precipitation of iodine at the first gas inlet and/or in a surrounding region thereof may be further suppressed.

The temperature of the first gas inlet may be controlled, for example, within a range of 120 °C to 550 °C, or 150 °C to 300 °C.

In an embodiment, the recovery system may further include a second temperature control unit configured to control the temperature of the first liquid inlet to be 100 °C or lower. That is, the recovery system may further include the second temperature control unit configured to control the temperature of the first liquid inlet to be 100 °C or lower. For example, the recovery system may control the temperature of the first liquid inlet to be at least 5 °C lower than a boiling point of the aqueous hydrogen iodide solution. Accordingly, vaporization of the aqueous hydrogen iodide solution may be prevented or suppressed.

In an embodiment, the recovery system 100 may further include a third temperature control unit configured to control the temperature inside the absorption tower 30 to be 100 °C or lower. That is, the recovery system 100 may further include the third temperature control unit configured to control the temperature inside the absorption tower 30 to be 100 °C or lower. The temperature inside the absorption tower 30 may be controlled, for example, within a range of 10 °C to 60 °C or 20 °C to 30 °C.

Therefore, vaporization of hydrogen iodide within the aqueous hydrogen iodide solution may be prevented, thereby preventing a further decrease in concentration. In addition, a reduction in an amount of gaseous iodine dissolved within the aqueous hydrogen iodide solution may be prevented or suppressed.

In non-limiting embodiments, the first to third temperature control units may include a heater, a heating wire, a thermoblock, a jacket-type heating means, and may also include a temperature sensor such as a thermocouple or a resistance temperature detector (RTD), as needed. The first to third temperature control units may be installed, for example, on an outer circumferential surface or inside each apparatus.

In an embodiment, the recovery system may further include a flow control unit configured to control a ratio of the molar flow rate of hydrogen iodide in the aqueous hydrogen iodide solution to the molar flow rate of gaseous iodine in the mixed gas supplied to the absorption tower 30 to be 0.7 or more. That is, the recovery system may further include the flow control unit configured to control the ratio of the molar flow rate of hydrogen iodide in the aqueous hydrogen iodide solution to the molar flow rate of gaseous iodine in the mixed gas supplied to the absorption tower 30 to be 0.7 or more. This ratio may be controlled to be, for example, 0.7 to 5, 1 to 4, or 2 to 3.

Accordingly, an amount of the gaseous iodine that is discharged without being dissolved in the aqueous hydrogen iodide solution may be effectively reduced.

In non-limiting embodiments, the flow control unit may include a mass flow meter, a volumetric flow meter, a pressure-regulating flow controller, a flow control valve, or the like.

In an embodiment, the flow rate of the mixed gas may be controlled to be 0.1 g/s to 10,000 g/s.

In an embodiment, the flow rate of the aqueous hydrogen iodide solution may be controlled to be 0.1 g/s to 100,000 g/s.

In an embodiment, a residence time of the mixed gas within the absorption tower 30 may be controlled to be within a range of 1 minute to 30 minutes, 1 minute to 20 minutes, 1 minute to 10 minutes, or 2 minutes to 5 minutes. The residence time may be defined, for example, as a time period from when the mixed gas is introduced into the absorption tower 30 until the mixed gas is discharged from the absorption tower 30.

In an embodiment, the recovery system further includes a first column 40, and may supply a first discharged liquid from the absorption tower 30 to the first column 40.

In an embodiment, the recovery system may discharge gaseous hydrogen iodide from the absorption tower 30.

In an embodiment, the recovery system may discharge a second discharged gas including hydrogen iodide and water from the first column 40 by distillation.

In an embodiment, the recovery system may discharge a second discharged liquid including liquid iodine (I₂) from the first column 40 by distillation.

For example, the second discharged gas may be discharged from an upper portion of the first column 40, and the second discharged liquid may be discharged from a lower portion of the first column 40. Descriptions of the upper portion and lower portion of the first column 40 may refer to the foregoing descriptions of the upper portion and lower portion of the absorption tower 30.

In an embodiment, the recovery system 100 may further include a caustic tower 70, and may supply a first discharged gas discharged from the absorption tower 30 to the caustic tower 70.

FIG. 5 is a schematic block diagram of an iodine recovery system 200 according to another embodiment of the present disclosure.

In an embodiment, the recovery system 200 may further include an iodine recovery unit 80, and the iodine recovery unit 80 may recover a second discharged liquid including liquid iodine (I₂) discharged from the first column 40. That is, the iodine recovery unit 80 may be configured to recover the second discharged liquid including liquid iodine (I₂) discharged from the first column 40.

In an embodiment, the second discharged liquid may include liquid iodine in an amount of 90 wt % or more, 95 wt % or more, 99 wt % or more, or 99.99 wt % or more based on the total weight of the second discharged liquid.

In an embodiment, the recovery system 100 may further include a reactor 60, and the second discharged liquid may be supplied to the reactor 60.

For example, iodine in a liquid state or a gaseous phase and other reaction raw materials may be mixed, either separately or together, and introduced into the reactor 60. A high-temperature reaction may then be carried out within the reactor 60, resulting in a product including a mixed gas including gaseous iodine (I₂) and gaseous hydrogen iodide. By applying the iodine recovery system, iodine included in the mixed gas may be efficiently recycled over along period of time while suppressing or reducing damage to apparatuses or equipment caused by precipitation or adhesion of iodine.

The other reaction raw materials may be sufficient as long as they are capable of producing a product including the mixed gas, and their types are not particularly limited.

In an embodiment, the recovery system may further include a second column 50, and the second discharged gas may be supplied to the second column 50.

In an embodiment, a third discharged gas including gaseous hydrogen iodide (HI), or including gaseous hydrogen iodide (HI) and water may be discharged from the second column 50. For example, the third discharged gas may be discharged from an upper portion of the second column 50.

In an embodiment, the recovery system may further include at least one connection line that connects the mixed gas supply unit, the reactor 60, the absorption tower 30, the iodine recovery unit, the first column 40, and/or the second column 50.

In an embodiment, the recovery system may supply the hydrogen iodide, the water, and/or the azeotropic mixture to the absorption tower 30 via a connection line that connects the second column 50 and the absorption tower 30. For example, the hydrogen iodide, the water, and/or the azeotropic mixture may be vaporized in the second column 50, and the vaporized hydrogen iodide, water, and/or the azeotropic mixture may be supplied therefrom to the absorption tower 30 via the connection line. For example, the vaporized hydrogen iodide, water, and/or the azeotropic mixture may be converted into an aqueous hydrogen iodide solution within the connection line.

For example, the temperature inside the connection line that connects the second column 50 and the absorption tower 30 may be set to be lower than the boiling point of the aqueous hydrogen iodide solution.

In an embodiment, the recovery system 200 may further include a caustic solution supply unit configured to supply a caustic solution to the caustic tower 70. Descriptions of the caustic solution refer to the foregoing descriptions.

In an embodiment, the recovery system 200 may further include a drying tower 90 connected to the caustic tower 70. Descriptions of the caustic tower 70 and the drying tower 90 refer to the foregoing descriptions. The iodine recovery system according to an embodiment may have an overall circulation structure, for example, wherein the iodine recovered through the absorption tower 30 and the first column 40 may be recycled, and/or the aqueous hydrogen iodide solution recovered through the first and second columns 40 and 50 may be recycled. Accordingly, consumption of raw materials may be minimized and process efficiency may be improved.

In an embodiment, the recovery system may further include the first supply unit 10 configured to supply a mixed gas including for example, gaseous iodine (I₂) and gaseous hydrogen iodide (HI).

When the mixed gas is supplied from the reactor 60, the first supply unit 10 may be omitted.

In an embodiment, the recovery system may further include a second supply unit 20 configured to supply an aqueous hydrogen iodide solution. That is, the recovery system may further include the second supply unit 20 configured to supply the aqueous hydrogen iodide solution. When the aqueous hydrogen iodide solution in a liquid phase is supplied through a connection line that connects the absorption tower 30 and the second column 50, the second supply unit 20 may be omitted.

For example, the absorption tower 30, the first and second columns 40 and 50, the iodine recovery unit 80, the caustic tower 70, the drying tower 90, the reactor 60, and the like may be connected to each other by connection lines, and apparatuses and equipment additionally used for recycling may also be connected via the connection lines.

For example, the absorption tower 30, the first and second columns 40 and 50, the iodine recovery unit 80, the caustic tower 70, the drying tower 90, the reactor 60, and the like may include one or more inlets and one or more outlets, through which gaseous or liquid fluids may be supplied or discharged.

In a non-limiting embodiment, the connection line may be pipes, tubes, or the like, and may be formed of stainless steel, carbon steel, or various alloys. Descriptions of the first and second discharged liquids, and the first to third discharged gases refer to the foregoing descriptions.

As used herein, the term “unit” refers to a device or apparatus having a specific structure and is not intended to be interpreted as a means-plus-function element.

For example, a “supply unit” may include a supplier (e.g., a supply device), a pump, a valve, a flow controller, a pipe, or a combination thereof, and may be configured to supply a fluid to a target location.

A “temperature control unit” may include a temperature controller, a heater, a cooler, a heat exchanger, or a combination thereof, and may be configured to control a temperature of a fluid or a system.

A “flow control unit” may include a flow controller, a valve, a mass flow controller (MFC), or a combination thereof, and may be configured to regulate a flow rate of a fluid.

An “iodine recovery unit” may include an absorption tower, a column, a reactor, a separator, a storage tank, or a combination thereof, and may be configured to recover and optionally store iodine from a fluid stream.

As used herein, the term “adhesion” refers to attachment of or retention of a material onto a surface, and encompasses various surface attachment phenomena, including but not limited to, physical adhesion and adsorption (e.g., physisorption and/or chemisorption).

### EXAMPLES AND COMPARATIVE EXAMPLES

### Example 1

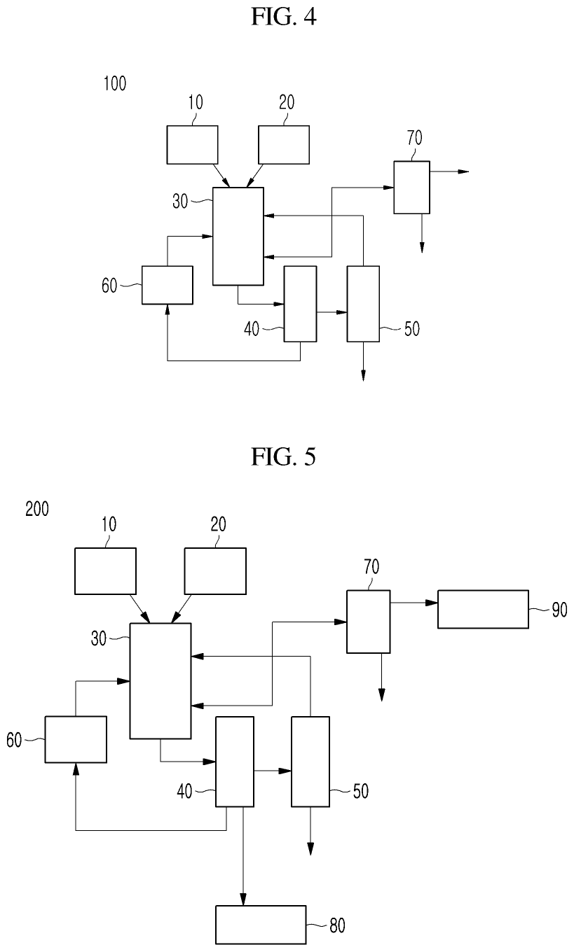

A system including: a first supply unit for supplying a mixed gas including gaseous iodine and gaseous hydrogen iodide; a second supply unit for supplying an aqueous hydrogen iodide solution in a liquid phase; an absorption tower that is respectively connected to the first supply unit and the second supply unit and into which the mixed gas and the aqueous hydrogen iodide solution are injected; a first column connected to the absorption tower; an iodine recovery unit connected to the first column; a second column connected to the first column, and connection lines that connect the foregoing components was designed, and an iodine recovery method was performed using the system. Specifically, a third discharged gas including hydrogen iodide and water discharged from the second column was cooled and condensed through the connection line, converted into an aqueous hydrogen iodide solution in a liquid phase, and then supplied back to the absorption tower. In this regard, the connection sequence refers to the corresponding configuration illustrated in FIGS. 4 and 5.

The specific process conditions were as follows:
Absorption tower structure: A first gas inlet through which the mixed gas is supplied and a first liquid inlet through which the aqueous hydrogen iodide solution is supplied are both formed at an upper portion of the absorption tower.
Mixed gas composition: 7.4 vol % of gaseous iodine, 26.8 vol % of hydrogen iodide, and 65.8 vol % of N₂ as an inert gas.
Temperature of the first gas inlet through which the mixed gas is supplied: 120 °C.
Supply flow rate of the mixed gas: 1 g/s.
Supply flow rate of the aqueous hydrogen iodide solution: 1 g/s.
Molar concentration of the aqueous hydrogen iodide solution: 3.6 mol/L.
Ratio of the molar flow rate of hydrogen iodide in the aqueous hydrogen iodide solution to the molar flow rate of gaseous iodine in the mixed gas: 4.9.

The molar flow rate was calculated based on the molecular weight of each component and the mixed gas composition.
Internal temperature of the absorption tower: 100 °C.

### Example 2

A system was designed in the same manner as in Example 1, except that the mixed gas composition was changed as follows:
Mixed gas composition: 7.4 vol % of gaseous iodine, 2.6 vol % of hydrogen iodide, and 90 vol % of N₂ gas as an inert gas.

### Example 3

A system was designed in the same manner as in Example 1, except that the temperature of the first gas inlet was changed as follows:
Temperature of the first gas inlet through which the mixed gas is supplied: 110 °C.

### Example 4

A system was designed in the same manner as in Example 1, except that the temperature inside the absorption tower was changed as follows:
Internal temperature of the absorption tower: 90 °C.

### Comparative Example 1

A system was designed in the same manner as in Example 1, except that the structure of the absorption tower was changed as follows:
Absorption tower structure: A first gas inlet through which the mixed gas is supplied is formed at a lower portion of the absorption tower, and a first liquid inlet through which the aqueous hydrogen iodide solution is supplied is formed at an upper portion of the absorption tower.

### Comparative Example 2

A system was designed in the same manner as in Example 1, except that the structure of the absorption tower was changed as follows:
Absorption tower structure: A first gas inlet through which the mixed gas is supplied and a first liquid inlet through which the aqueous hydrogen iodide solution is supplied are both formed at a lower portion of the absorption tower.

### Comparative Example 3

A system was designed in the same manner as in Example 1, except that the mixed gas composition was changed as follows:
Mixed gas composition: 100 vol % gaseous iodine.

### EXPERIMENTAL EXAMPLE

### Experimental Example 1: Evaluation of Iodine Precipitation/Adhesion

After each system was operated continuously for 500 hours, the presence of iodine precipitation and/or adhesion (including adsorption) was visually observed at the first gas inlet and a surrounding region thereof, to determine whether iodine precipitation or adhesion occurred. When solid iodine was precipitated and/or adhered, the result was indicated by a circle (o), and when no precipitation or adhesion were observed, the result was indicated by a cross (x).

The results are shown in Table 1.

### Experimental Example 2: Iodine Recovery Rate

Each system was operated continuously for 500 hours.

The total mass of gaseous iodine supplied to the absorption tower for 500 hours was calculated based on the flow rate of the mixed gas measured using a flow meter and the operating time, and was converted into a mass unit.

The total mass of liquid iodine recovered from the iodine recovery unit was measured using an electronic balance.

Based on the same mass unit, the iodine recovery rate was calculated as a percentage obtained by dividing the total mass of liquid iodine recovered by the total mass of gaseous iodine supplied.

The results are shown in Table 1.

TABLE 1

| | Occurrence of iodine precipitation | Iodine recovery rate |
|---|---|---|
| | or adhesion | (%) |
| Example 1 | x | 94 |
| Example 2 | x | 96 |
| Example 3 | x | 85 |
| Example 4 | x | 91 |
| Comparative | ∘ | 77 |
| Example 1 | | |
| Comparative | ∘ | 69 |
| Example 2 | | |
| Comparative | x | 81 |
| Example 3 | | |

Referring to Table 1, according to the iodine recovery methods and systems of the examples, no iodine was observed to precipitate, and the iodine recovery rate was improved to 85% or more.

Conversely, in the iodine recovery methods and systems according to Comparative Examples 1 and 2, the temperature of the gaseous iodine rapidly decreased as the mixed gas and the aqueous hydrogen iodide solution formed a counter-current flow, resulting in precipitation of iodine and a very low iodine recovery rate.

In the iodine recovery method and system according to Comparative Example 3, a single gas including 100 vol % of gaseous iodine was supplied to the absorption tower, resulting in a degraded iodine recovery rate.

Although embodiments of the present disclosure have been described for illustrative purposes, those skilled in the art will appreciate that various modifications, additions and substitutions are possible, without departing from the scope and spirit of the present disclosure. Therefore, the embodiments disclosed above and in the accompanying drawings should be considered in a descriptive sense only and not for limiting the technological scope. The technological scope of this disclosure is not limited by the embodiments and the accompanying drawings. The technical concepts and scope of this disclosure should be interpreted in connection with the appended claims and encompass all equivalents falling within the scope of the appended claims. Furthermore, the embodiments may be combined to form additional embodiments.

What is claimed is:

1. An iodine recovery method comprising supplying to an absorption tower, in a co-current flow, a mixed gas including gaseous iodine (I₂) and gaseous hydrogen iodide (HI), and an aqueous hydrogen iodide solution in a liquid phase.

2. The iodine recovery method according to claim 1, wherein the co-current flow is formed in a direction from an upper portion toward a lower portion of the absorption tower.

3. The iodine recovery method according to claim 1, wherein a volume ratio of the gaseous iodine (I₂) to the gaseous hydrogen iodide (HI) in the mixed gas is 10:1 to 1:20.

4. The iodine recovery method according to claim 1, wherein the absorption tower comprises a first gas inlet through which the mixed gas is supplied, and a temperature of the first gas inlet is set to 120 °C or higher.

5. The iodine recovery method according to claim 1, wherein the absorption tower comprises a first liquid inlet through which the aqueous hydrogen iodide solution in a liquid phase is supplied, and a temperature of the first liquid inlet is set to 100 °C or lower.

6. The iodine recovery method according to claim 1, wherein a ratio of a molar flow rate of hydrogen iodide in the aqueous hydrogen iodide solution to a molar flow rate of gaseous iodine in the mixed gas supplied to the absorption tower is set to 0.7 or more.

7. The iodine recovery method according to claim 1, wherein a temperature inside the absorption tower is set to 100 °C or lower.

8. The iodine recovery method according to claim 1, wherein a molar concentration of hydrogen iodide in the aqueous hydrogen iodide solution supplied to the absorption tower is 0.1 mol/L to 10 mol/L.

9. The iodine recovery method according to claim 1, further comprising supplying a first discharged liquid discharged from the absorption tower to a first column.

10. The iodine recovery method according to claim 9, further comprising discharging a second discharged gas including hydrogen iodide and water from the first column by distillation.

11. The iodine recovery method according to claim 9, further comprising discharging a second discharged liquid including liquid iodine (I₂) from the first column by distillation.

12. The iodine recovery method according to claim 10, further comprising recycling the second discharged gas.

13. The iodine recovery method according to claim 11, further comprising recycling the second discharged liquid.

14. An iodine recovery system comprising an absorption tower,
wherein a mixed gas including gaseous iodine (I₂) and gaseous hydrogen iodide (I), and an aqueous hydrogen iodide solution in a liquid phase are supplied to the absorption tower in a co-current flow.

15. The iodine recovery system according to claim 14, wherein the absorption tower comprises: a first gas inlet through which the mixed gas is supplied and a first liquid inlet through which the aqueous hydrogen iodide solution is supplied in a liquid phase, at an upper portion thereof, and
a first liquid outlet through which a first discharged liquid is discharged and a first gas outlet through which a first discharged gas is discharged, at a lower portion thereof.

16. The iodine recovery system according to claim 14, further comprising a mixed gas supply unit configured to control a volume ratio of the gaseous iodine (I₂) to the gaseous hydrogen iodide (HI) in the mixed gas to be 10:1 to 1:20.

17. The iodine recovery system according to claim 15, further comprising a first temperature control unit configured to control a temperature of the first gas inlet to be 120 C or higher.

18. The iodine recovery system according to claim 15, further comprising a second temperature control unit configured to control a temperature of the first liquid inlet to be 100 °C or lower.

19. The iodine recovery system according to claim 14, further comprising a flow control unit configured to control a ratio of a molar flow rate of hydrogen iodide in the aqueous hydrogen iodide solution to a molar flow rate of gaseous iodine in the mixed gas supplied to the absorption tower to be 0.7 or higher.

20. The iodine recovery system according to claim 14, further comprising a third temperature control unit configured to control a temperature inside the absorption tower to be 100 °C or lower.
